(19) United States
(12) Patent Application Publication
(10) Pub. No.: US 2016/0055431 A1
(43) Pub. Date: Feb. 25, 2016

(54) SYSTEM AND METHOD FOR GENERATING ITINERARIES AND WEATHER FORECAST DISPLAYS

(71) Applicant: MASTERCARD INTERNATIONAL INCORPORATED, Purchase, NY (US)

(72) Inventor: Justin X. Howe, Oakdale, NY (US)

(73) Assignee: MASTERCARD INTERNATIONAL INCORPORATED, Purchase, NY (US)

(21) Appl. No.: 14/464,273

(22) Filed: Aug. 20, 2014

(51) Int. Cl. G06Q 10/02; G06Q 50/14

(52) U.S. Cl. CPC G06Q 10/025; G06Q 50/14

(57) ABSTRACT

A computer system is configured to generate travel itineraries from databases of travel data, the itineraries including ordered location and date data, and provide itineraries to user devices for generation of displays of weather forecast data for locations on the itinerary. A user device is configured to access itinerary data, generated from databases of travel data, and weather forecast data, and generate a display of weather forecast data for locations on the itinerary.

### CROSS-REFERENCE TO RELATED APPLICATIONS

None.

### FIELD OF INVENTION

The present invention relates to generation of user-customized weather forecast displays. More particularly, the invention relates to systems and methods for generating user itineraries based on travel data and generating weather forecast displays based on the predicted future user locations.

### BACKGROUND

Weather forecasts are an important planning tool for travelers. For such decisions as selection of clothing, types of activities to plan, and other decisions, weather forecasts are important for the traveler. While weather forecast data for upcoming days can readily be obtained and displayed, such as using application programs installed on smartphones, tablets and other mobile devices, the displayed weather forecasts are provided for the user's present location. The user must manually select future geographic locations to view forecasts for locations where the user plans to travel.

Certain present systems permit the user to manually provide itinerary information, and, in response, the system will provide a display of weather forecasts for locations in the itinerary.

Alternative systems and methods for providing weather forecast data for display on user devices, particularly without user entry of itinerary data, are desired.

### SUMMARY

In embodiments, systems and computer-implemented methods provide for the generation of weather forecast displays, correlated with anticipated locations of a user, based on data including travel itinerary data. In one embodiment a computer system includes one or more data storage devices storing data indicative of user identification data and travel data associated with user identification data, one or more processors and a memory in communication with the one or more processors and storing program instructions. The one or more processors are operative with the program instructions to identify travel events associated with a user based on the data indicative of user identification data and travel data; generate, based on the travel events, an itinerary comprising an ordered list of correlated date data and location data; and provide the itinerary to a user device for display of a weather forecast comprising correlated date, location and weather forecast data in accordance with the itinerary data.

In embodiments, a computer-implemented method for data processing for determining travel itineraries for display of location-specific weather forecast data on user devices, includes storing in one or more data storage devices data indicative of user identification data and travel data associated with user identification data; identifying by one or more computer processors travel events associated with a user based on the data indicative of user identification data and travel data; generating, by the one or more computer processors, based on the travel events, the itinerary comprising data indicative of an ordered list of correlated date data and location data; and providing by the one or more computer processors data from the itinerary to a user device for display of a weather forecast comprising correlated date, location and weather forecast data in accordance with the itinerary data.

In another embodiment, a device for generating a display of weather forecast data in accordance with an itinerary generated by a system from travel events, includes one or more processors; a memory in communication with the one or more processors and storing program instructions, the one or more processors operative with the program instructions to: request itinerary data via a network from a computer system having itinerary data; receive itinerary data, comprising an ordered set of correlated dates and locations generated from travel data; request, for each of the locations in the itinerary data, from a weather forecast server system, weather forecast data; receive, for each of the locations in the itinerary data, weather forecast data; correlate each date and location in the itinerary data with received weather forecast data, including generating a list of ordered sets of display data; and generate a display of forecast data for dates and locations in the itinerary.

### BRIEF DESCRIPTION OF THE DRAWINGS

FIG. 1 illustrates a system architecture within which some embodiments of the present disclosure may be implemented.

FIG. 2 is a functional block diagram of a managing computer system for a payment card service provider in accordance with an exemplary embodiment of the present disclosure.

FIG. 3 illustrates a process flow diagram of an exemplary process of determining itineraries for use in providing customized weather forecast displays on user devices based on predicted future locations of the user according to an embodiment of the present disclosure.

FIG. 4 illustrates a table including exemplary travel event data useful in implementing aspects of the present system and method.

FIG. 5 illustrates a table including exemplary itinerary data determined in connection with an embodiment of the present system and method.

FIG. 6 illustrates an exemplary process flow for managing communication of itinerary data with a user device according to an embodiment of the present disclosure.

FIG. 7 illustrates a functional block diagram of a mobile user device in accordance with an exemplary embodiment of the present disclosure.

FIGS. 8A-8B illustrate an exemplary process flow for generation of weather display data according to an embodiment of the present disclosure.

### DETAILED DESCRIPTION

Disclosed herein are processor-executable methods, computing systems, and related processing for the generation of weather data customized for a user's travel plans. Embodiments of the system may be configured to receive and access travel itinerary data, such data indicative of airline date and flight number associated with an individual traveler's ticket purchases, as well as similar data relating to rail travel, cruise line and other water travel, by way of example. The received travel itinerary data may be processed for determining predictions of geographic locations of an individual traveler at predicted future times, using one or more rules for application to the travel itinerary data. The predictions of geographic locations may be employed in selecting weather prediction data for future time periods, and then display of the weather predictions according to the predicted geographic locations on a user device. Accessed data may include non-cash payment data, such as payment card transaction record data, and global distribution services data, as well as airline billing service provider data. Non-cash payment data, such as payment card transaction record data, may include customer information, merchant information, and data such as flight and airline information, flight dates, arrival dates, departure dates, hotel locations, and other data. Transaction record data and other data indicative of travel arrangements may be stored in one or more databases, searched to identify data associated with an individual user of a location predictive weather display application program, by way of example, and the identified data extracted and processed to predict future geographic locations of the user.

While embodiments of the present disclosure will generally be described herein in the context of identifying airline travel plans and associating weather prediction data with predicted geographic locations determined based on airline travel data, it should be understood that similar systems and methods may be implemented to determine predicted geographic locations based on other location-specific payment transaction data and generate displays of weather data customized for predicted geographic locations based on such other payment transaction or other data.

A “payment card processing system” or “credit card processing network” or “card network”, such as the MasterCard network exists, allowing consumers to use payment cards issued by a variety of issuers to shop at a variety of merchants. With this type of payment card, a card issuer or attribute provider, such as a bank, extends credit to a customer to purchase products or services. When a customer makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the customer's signature is also verified, a personal identification number is required or other user authentication mechanisms are imposed. The customer is required to repay the bank for the purchases, generally on a monthly basis. Typically, the customer incurs a finance charge for instance, if the bank is not fully repaid by the due date. The card issuer or attribute provider may also charge an annual fee.

As used herein, the term “processor” broadly refers to and is not limited to a single- or multi-core general purpose processor, a special purpose processor, a conventional processor, a Graphics Processing Unit (GPU), an Applications Processing Unit (APU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

It is to be understood that sources of data include data relating to non-cash payments, including payments via payment cards, digital wallets, key fobs, far field radio frequency identification transactions, and other non-cash payment arrangements. A payment card is a card that can be presented by the cardholder (i.e., customer) to make a payment. By way of example, and without limiting the generality of the foregoing, a payment card can be a credit card, debit card, charge card, stored-value card, or prepaid card or nearly any other type of financial transaction card. Payment card transactions include mobile device-linked payment card transactions, by way of non-limiting example. It is noted that as used herein, the term “customer”, “cardholder,” “card user,” and/or “card recipient” can be used interchangeably and can include any user who may employ a non-cash payment arrangement, such as a holder of a payment card, for making purchases of goods and/or services. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a non-cash payment system such as a payment card, a digital wallet, a payment card. As used herein, the term “transaction acquirer” can include, for example, a merchant, a merchant terminal, an automated teller machine (ATM), or any other suitable institution or device configured to initiate a financial transaction per the request of the customer or cardholder.

“Airline itinerary data” includes data indicative of a traveler, identified by such data as name, non-cash payment record data such as payment card data, frequent flier or other reward account number, flight number, airline identifier, flight date, origin and destination airports, fare class, and other data. Sources of airline itinerary data include non-cash payment transaction data, data from global distribution service systems, such as Amadeus, Travelport, Abacus and Sabre, and airline billing service providers.

As set forth above, embodiments of the present disclosure relate to systems and methods for generating customized displays of weather forecast data based on predicted geographic locations of a traveler determined based on travel itinerary data. A method according to embodiments of the present disclosure includes the following illustrative steps. First, a determination of a travel itinerary of an individual associated with a display device is made. The travel itinerary determination may be made via rule-based processing of data including non-cash payment transaction data, airline data, rail data, rental car data, hotel reservation data, and other travel and entertainment purchase data. For example, separate data sources may furnish periodic uploads of travel-related data, including user identification data, such as non-cash payment device (e.g., digital wallet) identifier, payment card number, name and address data, and travel data including dates, locations, flight departure and arrival airports, flight numbers, rail departure and arrival dates, hotel location, arrival and departure dates, and the other date and location data. From the uploaded data, the data relating to a user may be identified, extracted, and analyzed using a rules-based process to determine one or more travel itineraries. A determined travel itinerary may include correlated dates and locations, such as cities, postal codes, or other location identifying information, associated with an individual. As the travel itinerary is determined by a system from travel data, which may include non-cash payment transaction data, airline itinerary data, and other data, the travel itinerary is determined without requiring the user to provide itinerary data.

The determined itinerary is then correlated with weather forecast data. For example, a user device, such as a smartphone, tablet, laptop, notebook, or desktop computer, may access weather forecast data for dates and locations corresponding to the determined travel itinerary. Weather forecast data may be obtained from one or more of governmental weather forecast data sources, such as the National Weather Service, and commercial weather forecast data sources, such as Accuweather, Weather Underground, and other commercial weather forecast data sources. Obtained weather forecast data may be of a quantity suitable for display on a portable device, such as a smartphone screen. Thus, obtained weather forecast data may be limited to data items such as: forecast high temperature, forecast low temperature, and, if precipitation is likely, likely precipitation type. In embodiments, a local application program (app) may be stored in non-transitory computer-readable media on the user device and include instructions to cause one or more computer processors of the user device to receive on a periodic basis an indication of a travel itinerary, and, responsive to receipt of a travel itinerary, access weather forecast data, and, using, for example, template multi-day weather forecast displays in html or other script, generate a multi-day weather forecast display indicating both the location and the weather forecast data. In other embodiments, the correlation of itinerary data and weather forecast data may be performed by another system, and correlated data provided to the user device for display generation. Thus, the user device may be configured to display, in two or more generally sequential areas of a screen, a day of the week or date, a location, such as a city name, and weather forecast data, such as high and low temperature, and text and/or pictorial data representing forecast weather conditions, such as sunny, partly cloudy, cloudy, rain, snow, sleet and other forecast weather conditions. In embodiments, each area of the screen may represent a single calendar day. In other embodiments, each area of the screen may represent a portion of a day, such as a morning, afternoon, and evening of a single day in separate areas of the screen. In other embodiments, a single area of the screen may be provided for each location where the itinerary provides for the individual staying for the entire day, and a separate area of the screen for each portion of a day associated with a different location.

In embodiments, display information may include additional weather forecast details, such as likelihood of precipitation, forecast temperatures at particular hours of the day, and severe weather warning information. In embodiments, the display may include a prompt for a user to update or correct itinerary data by providing, such as on a map displayed on a touchscreen, corrected itinerary data.

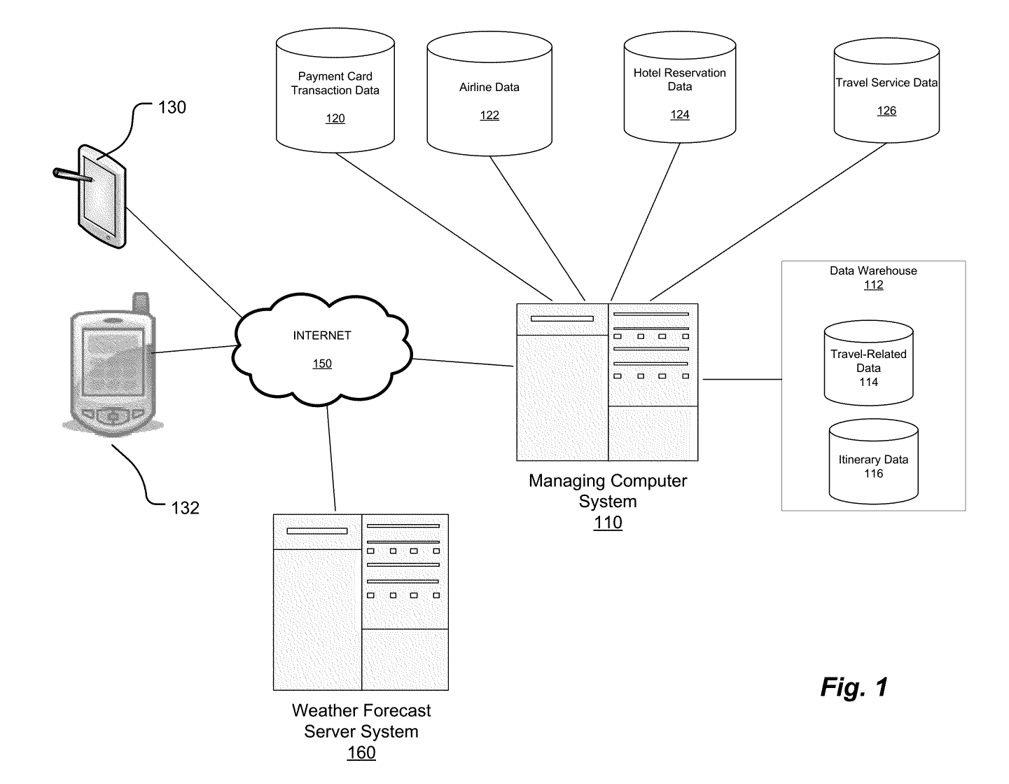

Referring now to FIG. 1, there is shown a high-level diagram illustrating an exemplary system for determining travel itineraries and displaying travel-itinerary sequences of weather forecast data on user devices according to an embodiment of the disclosure. As shown in FIG. 1, the system 100 includes a managing computer system 110 that includes a data storage device or data warehouse 112. Managing computer system 110 may be managed by or on behalf of a payment card processing entity. The data storage device or data warehouse 112 stores data indicative of user travel arrangements, and determined user travel itineraries. Managing computer system 110 receives data from at least one source, the sources including non-cash payment data such as payment card transactions 120, airline data 122, hotel reservation data 124, travel service data 126, in this example. Managing computer system receives and stores non-cash payment transaction data, airline data 122, hotel reservation data 124 and travel service data 126 in data storage device 112. Managing computer system 110 exercises a search and analysis routine to generate travel itineraries for individuals having payment cards or other non-cash payment devices and arrangements. By way of example, managing computer system 110 may conduct searches on a periodic basis to identify, for each of a set of individuals, travel-related records associated with those individuals. The set of individuals may be defined, for example, by those individuals who have downloaded, installed, configured or confirmed installation and use of an application program for providing weather forecast data for locations in a travel itinerary. The individuals may be identified by payment card number, name, address, Social Security number, frequent flier and other rewards program numbers, and other identifying data in stored data. Using a database management system, the managing computer system 110 organizes, manages and conducts searches on travel-related data. The managing computer system 110, responsive to obtaining data indicative of travel plans of an individual, such as airline data such as flight numbers, dates, departure airport, and destination airport, and based on rules, such as a rule providing that absent travel data, an individual is in a given location from an arrival event, such as an arriving flight, until a departure event, such as a departing flight or departing rail reservation, generates a travel itinerary, which is stored in itinerary data database 116. Travel itinerary data may be associated with a payment card holder or other non-cash payment device holder, and include a travel start date, a travel end date, and locations associated with each date and in embodiments, portions of dates, between the travel start date and the travel end date. The itinerary data may be an ordered list of sets of dates and locations, for example.

Managing computer system 110 may execute rules for determining when and whether to provide travel itinerary data to devices 130, 132 of user. Devices 130, 132 include processors, communication devices such as wireless devices configured for connection via network 150 with managing computer system 110 over cellular telephone networks, wi-fi networks and other wireless data networks, as well as in embodiments via local area networks (LANs) and other wired communication networks. Managing computer system may store rules that provide for transmitting itinerary data a certain number of days, or other time period, prior to a travel start date of a trip. By way of example, an application program executing on device 130, 132, may be configured to display weather data for a current date and a particular number of consecutive future dates, such as the next three to six dates.

Various protocols may be employed to transmit itinerary data from the managing computer system to the user device 130, 132. By way of example, the managing computer system may execute a daily routine to determine if the itinerary data store 116 includes itinerary data for any subscribed user for a final display day for the next calendar date, such as a date four days from the next calendar date, and push itinerary data for final display day to identified user devices. In another embodiment, user devices 130, 132 may be configured to request itinerary data for the final display day for the next upcoming calendar day from the managing computer system on a daily basis. The final display day may vary from device to device, such as depending on user selection of displays of three day, five day or ten day forecasts. The managing computer system may be configured to search the itinerary database 116 for itinerary data for the requested day responsive to the request, and provide either an indication of no itinerary, or the requested itinerary data. In other embodiments, the managing computer system may furnish itinerary data to the user device upon determination of an itinerary. The user device may store the itinerary data locally, and check itinerary data on a daily or other suitable cycle. Upon receipt of itinerary data, the user device may be configured to overwrite earlier-received itinerary data for a same time period.

User devices 130, 132, on a daily or other cycle, determine a set of weather forecast data needed for a multi-day forecast display. Upon determination of the set of weather forecast data needed, including location and associated date data for each date in the forecast display, the user devices may request of the weather forecast server system 160, such as via an API or RSS feed, the weather forecast data by location, date, time and the like. If a selected API or RSS feed is configured only to provide a multi-day forecast for a single location per request, the user device may provide separate requests for each location in the travel itinerary. Upon receipt of the requested data, the user devices may incorporate the data in a template display including display portions corresponding to each of the upcoming dates or other time intervals. The user device may select data from API requests for multiple locations in accordance with date/location pairs or sets in the itinerary prior to populating a display template. The user devices may employ the same set of weather forecast data needed for the next display cycle, such as a 24 hour display cycle. In the event of receipt of modified itinerary data during the display cycle, then the user device may update the set of weather forecast data needed, and issue a request to the weather forecast server system 160 for updated data.

In embodiments, a system other than user devices 130, 132 may determine a set of weather forecast data needed for a forecast for a given user or user device, request weather forecast data from weather forecast server system 160, receive the requested weather forecast data, correlate itinerary data and weather forecast data, and provide correlated itinerary data and weather forecast data to the user devices. User devices 130, 132 may then incorporate the received itinerary data and weather forecast data and generate the display. In embodiments, managing computer system 110 may be configured to perform these steps. Managing computer system 110 may store correlated itinerary data and weather forecast data and push the data to the user devices on a schedule, or dependent on identification of changes in forecasts. In embodiments, user devices 130, 132, may periodically request correlated itinerary data and weather forecast data from managing computer system 110. In embodiments, a system other than managing computer system 110 may perform steps of determining needed weather forecast data, requesting and receiving weather forecast data, correlating the weather forecast data with itinerary data, and providing the weather forecast data correlated with itinerary data, to user devices.

The network 150 can be virtually any form or mixture of networks consistent with embodiments as described herein include, but are not limited to, telecommunication or telephone lines, the Internet, an intranet, a local area network (LAN), a wide area network (WAN), virtual private network (VPN) and/or a wireless connection using radio frequency (RF) and/or infrared (IR) transmission to name a few.

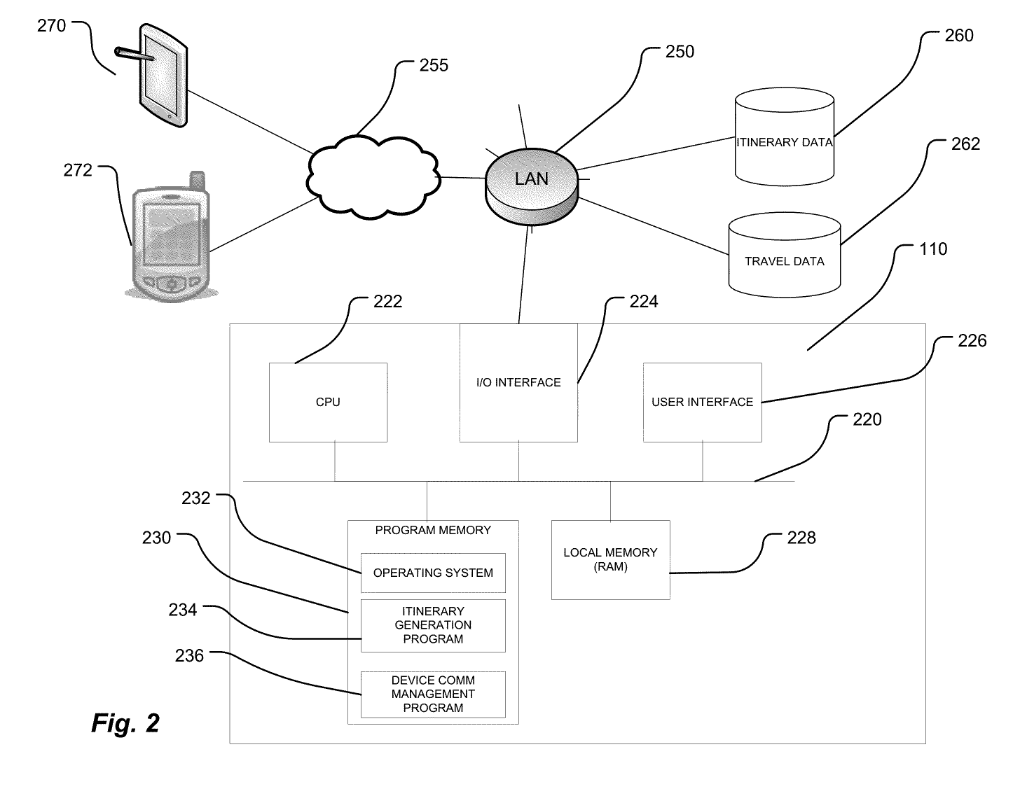

Referring now to FIG. 2, an exemplary embodiment of a managing computer system 110 for the payment card service provider is shown. Computer system 110 includes exemplary data bus 220 providing communication among system components. One or more computer processors, designated by central processing unit (CPU) 222, is in communication via data bus 220 with components including program memory 230, local memory 228, user interface 226, and input/output interface 224. Program memory 230 stores programs including an operating system (OS) 232, which manages the computer hardware and provides common services for efficient execution of various logic circuitry including hardware, software and/or programs. Program memory 230 further stores itinerary generation program 234, which includes computer-executable instructions to execute rules to generate itineraries based on results of searches of travel data. In embodiments, program memory 230 may include computer-executable instructions to execute rules to request and obtain weather forecast data and generate correlated itinerary data and weather forecast data. Program memory 232 further includes device communication management program 236, which includes computer-executable instructions to manage communications, particularly communications of itinerary data, and in embodiments correlated weather forecast and itinerary data, with user devices. The processor 222 (or CPU) carries out the instructions of computer programs, which operates and/or controls at least a portion of the functionality of the managing computer system 110. Program instructions may be loaded into local memory 228 for efficient and high-speed execution by CPU 222. Programs may be arranged in one or more modules, and functionality of programs may be implemented in program code that may be arranged as one or more programs or modules, which need not be stored on a same memory device, or executed by a single CPU.

System 110 further includes device input/output interface 224 configured to receive and output network data, travel data, itinerary data, weather forecast data, user device request data and information to and/or from managing computer system 110 from and/or to peripheral devices and networks operatively coupled to the system. Such networks may include exemplary local area network 250, which manages communications among devices within a card services provider system or third party system. Data storage devices and associated management systems, such as hardware and software for database management systems, may be coupled to local area network 250, and include itinerary data storage 260, storing itineraries determined by system 110 executing instructions of itinerary generation program 234, and travel data storage 262, which may store data from sources such as airline systems, reservation systems, hotel systems and other systems. Local area network 250 may further be coupled, via one or more intermediary communication devices, such as firewall systems and other access management systems, (not shown), to network 255, which may be or include the Internet, as well as other wired and/or wireless networks, to user devices such as tablet computer 270 and smartphone 272. The I/O interface 224 may include a query interface configured to accept and parse requests from user devices 270, 272, and pass those requests to CPU 222 for processing using instructions of device communication management program 236, for itinerary data for use in generating weather displays, as well as for user permissions and verification, by way of example. The I/O interface 224 may be configured to push data, such as updated itinerary data, or correlated itinerary and weather forecast data, to user devices 270, 272, even in the absence of a request, in embodiments.

The program memory 230 may include one or more of any form of data storage device including but not limited to electronic, magnetic, optical recording mechanisms, combinations thereof or any other form of memory device capable of storing data. The CPU 222 may be in the form of one or more computer processors, or may be in such forms as a distributed computing system, a centralized computing system, a network server with communication modules and other processors, or nearly any other automated information processing system capable of executing instructions stored in program memory. The managing computer system 110 may be embodied as a data warehouse or repository for storing, managing and processing volumes of travel data received from a variety of sources on a periodic or continuous basis.

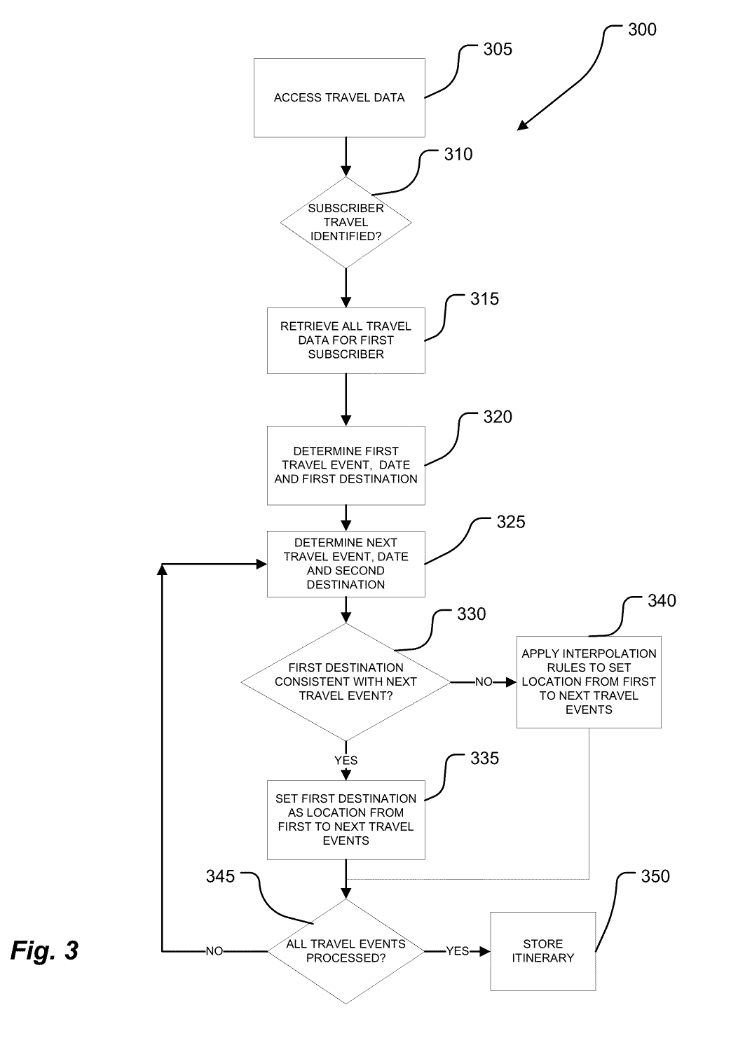

Referring now to FIG. 3, an exemplary process flow diagram is shown of a method 300 for generating an itinerary for a user based on travel data. Method 300 may be implemented, by way of example, by CPU 222 of FIG. 2 executing instructions stored in itinerary generation program 234. One or more steps of method 300 may be executed by other programs and devices, such as one or more database management programs. Referring to FIG. 3, system 110 accesses 305 travel data, such as airline data and other data stored in one or more data storage devices. System 110 may interact with one or more database management programs to initiate search queries for subscriber identifying data, such as payment card number, and name and address data. The term “subscriber” may refer to an individual payment card holder who has agreed to permit systems to search for travel data and to generate itineraries and location-specific weather forecast displays based on generated itineraries. The system may conduct searches in databases of travel data to identify travel events associated with subscribers. A “travel event” is an event indicative of travel by a subscriber. A travel event may be an airline flight, a rail journey, a hotel reservation, a rental car reservation, a restaurant reservation, an entertainment or leisure purchase, such as a theater tickets, sporting event tickets, tickets for an entertainment venue such as an amusement park or leisure park, or other event. A travel event preferably includes data indicative of at least one location, such as destination and arrival airports, and a date.

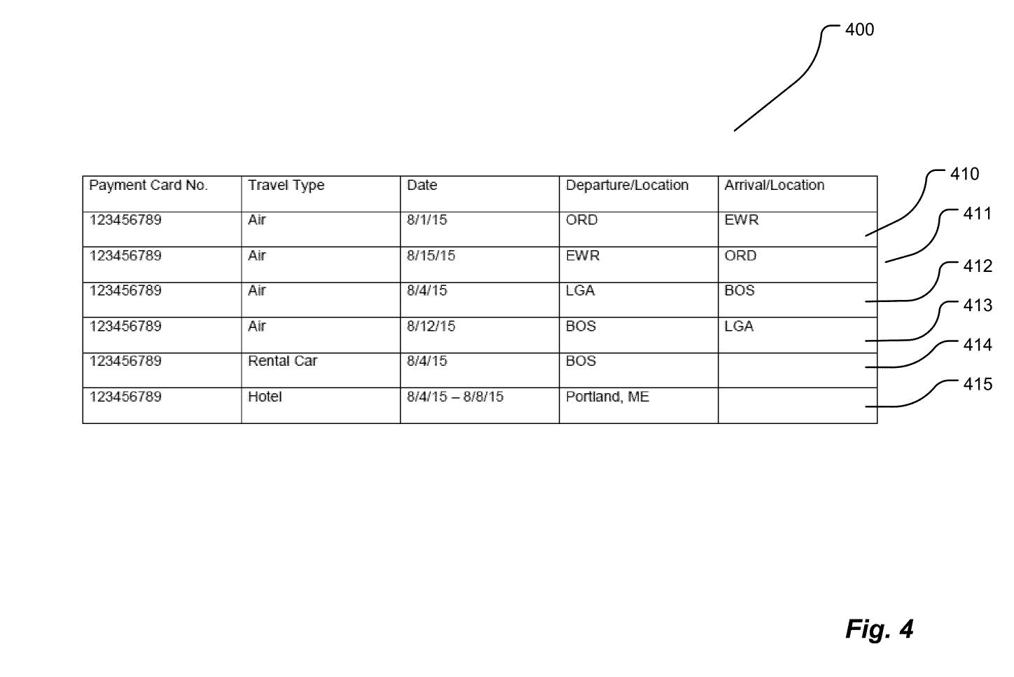

If subscriber travel is identified 310 in a search of a travel data database, then all available travel data for a first subscriber is retrieved 315 for analysis. Travel data for a subscriber may include a plurality of travel events. Referring to FIG. 4, table 400 shows an exemplary excerpt from retrieved data showing a plurality of travel events 410-415. The process flow proceeds to determining 320 a first travel event of the retrieved or identified travel events, based on date information. The date and at least a first destination of the first travel event are determined. In the example, the first travel event is a flight from O'Hare Airport to Newark Airport, with a date of Aug. 1, 2015. The system may perform an analysis to determine that the determined first travel event is a valid first travel event, using validation rules. For example, a validation rule may require that the location of the first airport may be compared to a billing address of a subscriber to determine if a correct first event has been identified. If the distance between the billing address and the first event is above a threshold value, then, in accordance with the validation rule, the first event may be determined not to be a valid first travel event. In response to the determination that the determined first travel event is not a valid first travel event, the system may be configured to conduct further travel data searches, as an earlier travel event, such as an initial flight may not have been retrieved. Alternatively, the determination that the determined first travel event is not a valid first travel event may indicate a purchase of a ticket for another person, or another data error.

Responsive to verification that the first travel event is a valid first event in an itinerary, the system proceeds 325 to determining a next travel event, a date and a next destination. If the first destination location and the next departure location are consistent, such as being the same airport, then a city associated with the airport may be set as the location in the itinerary from the first to the next travel event 335. One or more rules may provide that, responsive to such consistency, setting a location associated with both a destination of the first travel event and a departure of the second travel event as an itinerary location for all dates between the first and second travel events. In the example of FIG. 4, the next travel event is travel event 412, which is a flight from New York LaGuardia Airport to Boston. The system then compares the location data of the first travel event with the location data of the next travel event to determine consistency. In this example, the destination of the first travel event is Newark, N.J., and the departure of the second travel event is New York, N.Y. In an embodiment, these locations may both be considered New York, N.Y., and New York, N.Y., may be set as the user's location from first travel event to next travel event. If the locations not within a same location definition, such as a New York metropolitan area definition, then the process flow may proceed to using interpolation rules 340 to set a location for the user from the first travel event date to the second travel event date. For example, the interpolation rules may assume that the user is at the first location until the next travel event date, assume that the user at the next location, assume that the user is at an intermediate destination, such as a resort or other location, or use other interpolation rules.

Once the location of the user through the second travel event has been set, the system then proceeds to determine if all travel events have been processed 345. If all travel events have been processed, the itinerary is then stored 350. If not all travel events have been processed, then the process flow returns to block 325 to determine the next travel event.

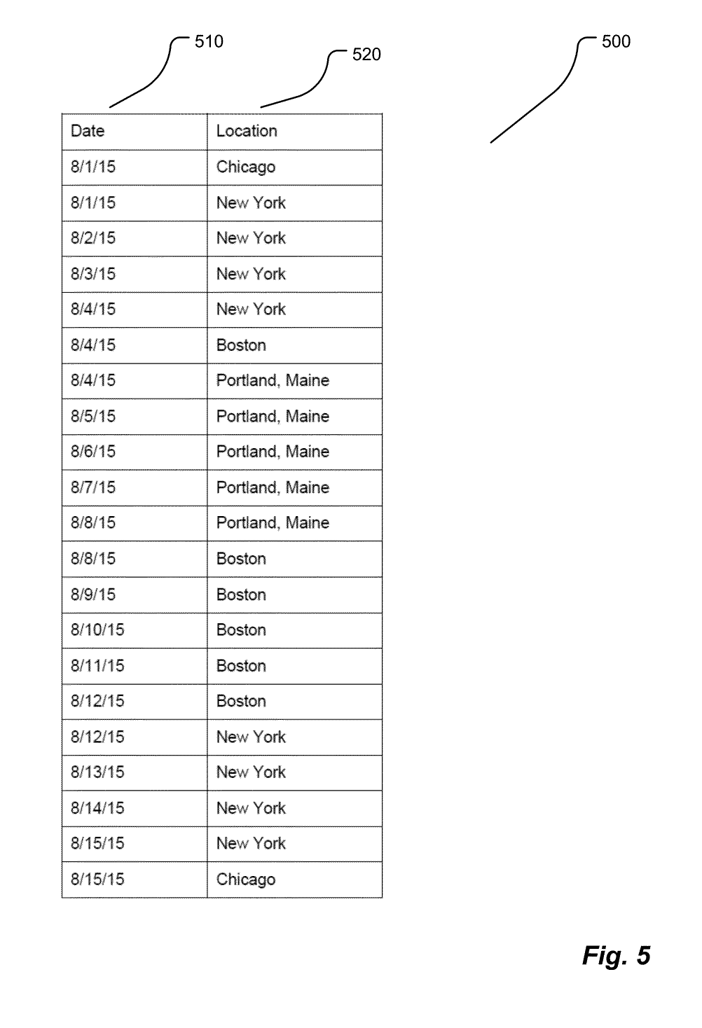

In the example of FIG. 4, the itinerary will continue by adding Boston, based on the flights to and from Boston. The rental car travel event 414, combined with the hotel travel event 415 having location data in Portland, Me., causes the system to determine itinerary dates including Portland, Me. Thus, the resulting itinerary determined will include dates associated with Portland, Me. Processing of travel event 413, a flight from Boston to New York's LaGuardia airport, on 8/12/14, combined with travel event 411, a flight from Newark airport to Chicago on Aug. 15, 2014, results in, by use of interpolation rules, that the user's location is assigned as New York for Aug. 13, 2015 and Aug. 14, 2015. Accordingly, an example itinerary is shown in FIG. 5 as a two column table 500. The table includes dates, and one or more locations associated with each date. In embodiments, the data from this table is provided to a user device in suitable structured format, such as in an xml format message. The itinerary data may be employed by a user device, executing suitable program code, in selecting weather data to be requested, and in generating a weather display. The arrangement of itinerary data in a table is merely exemplary, and any other suitable data arrangement may be employed.

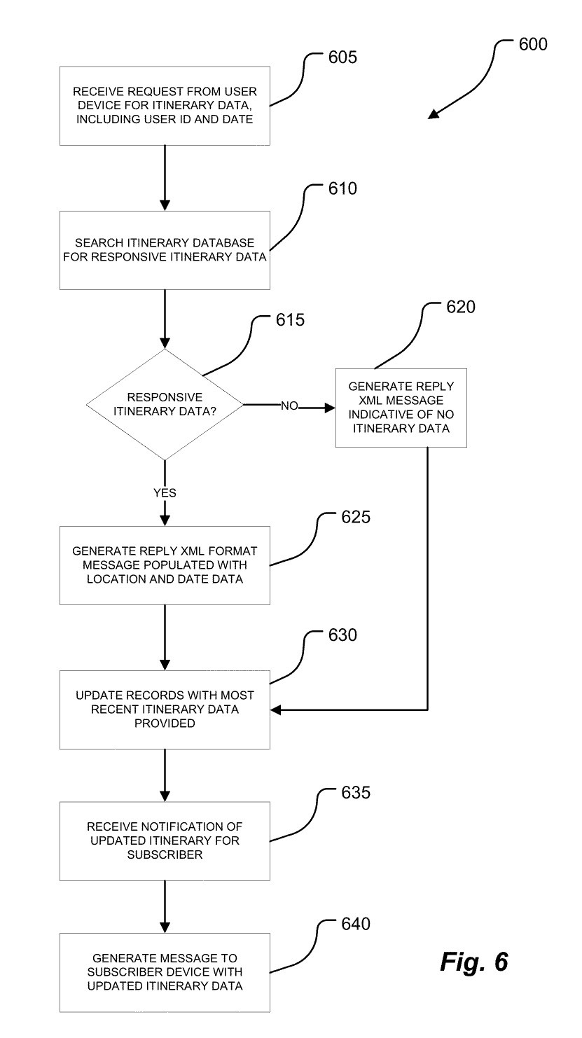

Referring now to FIG. 6, there is shown an exemplary process flow 600 for managing communications between a management system and a user device in an embodiment of a system and method according to the present disclosure. Process flow 600 may be implemented by CPU 222 of computer system 110 of FIG. 2, executing instructions of device communication management program 236 stored in program memory 230. Referring again to FIG. 6, a request is received 605 from a user device for itinerary data. The request may include data identifying the user, the user device, or both. In embodiments, the request may include the date or date range sought by the user device. The request may be in a suitable format, such as an xml format message having fields identifying the request or transaction type as a request for itinerary data for use in weather display generation, user identification, begin date and end date. The request is received via I/O interface 224 of FIG. 2, and provided to CPU 222. Referring again to FIG. 6, the itinerary database is searched 610 for responsive itinerary data. Responsive itinerary data may include itinerary data associated with a user identification, such as a payment card number or other user number, corresponding to the user identification received in the request. Responsive itinerary data may be filtered via date range constraints. A database management system may receive the search request, formatted in a suitable format, from device communication management program 236, execute the search in itinerary database 260, and return search results in a suitable format to device communication management program 236.

The process flow then proceeds to determining if responsive itinerary data has been returned 615 in response to the request. The determination may include checking the returned search results to see if a message indicative of no responsive records is returned, or if one or more responsive records are returned. Responsive to a determination that no responsive itinerary data has been received (i.e., no responsive records are returned), then a reply message, in xml format or other suitable format, is generated 620 indicating that no itinerary data has been identified. The xml format message may include fields or tags identifying message type, message content, such as a YES/NO field for itinerary data identified, and user device and/or user identification data. The reply message indicative that no itinerary data has been identified is returned to the user device.

Responsive to a determination that responsive itinerary data has been identified, the process flow proceeds to generation 625 of a reply message populated with returned itinerary data. The returned itinerary data may include location and date data, such as the exemplary location and date data shown in FIG. 5. In embodiments, the reply message may be in xml format.

Following generation of a reply message, the process flow proceeds to updating 630 records identifying time and most recent itinerary data furnished to the user device. The time and most recent itinerary data records may be stored locally or in an itinerary data database.

In an embodiment, generation of an updated itinerary for a subscriber may result in data indicative of an updated itinerary being provided to the user device communications management program. In this embodiment, the process flow may include a step of receiving 635 notification of an updated itinerary for a subscriber. The notification may be a suitable message or set of messages including subscriber or user device identification, and correlated date and location data. The process flow may then proceed to generating 640 an outgoing message to the subscriber device with the updated itinerary data. The outgoing message may have the same format as the reply message provided in response to a request from a user device.

In embodiments, the process flow shown in FIG. 6 may include receiving and responding to requests for correlated itinerary and weather forecast data from user devices, and updating stored records identifying timing of providing such data, by way of example.

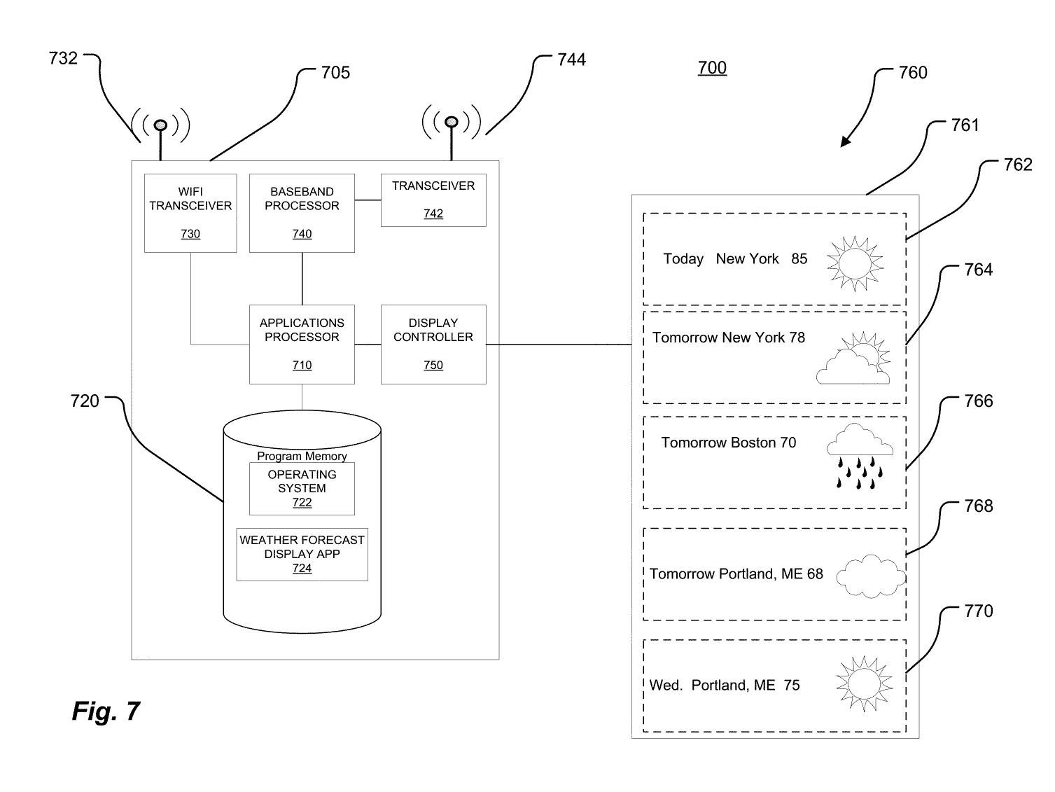

Referring now to FIG. 7, a schematic system diagram of a user device 700 is shown. Illustrated user device 700 is a smartphone, but embodiments of the system may be accomplished with other types of user devices, including tablet computers, laptop computers, desktop computers, personal digital assistants, smart watches, and other devices. While in the following description, the processing steps for generation of a display of weather forecasts associated with locations in accordance with an itinerary are performed by processors of the smartphone, in other embodiments, one or more of the processing steps may be performed by other computer systems, such as cloud based systems, a payment card processor computer system, a weather data source computer system, and other remote computer systems.

At 710, an exemplary schematic diagram of a user device is shown. User device 705 includes applications processor (APU) 710, which includes one or more processors for executing a smartphone operating systems, such as a version of iOS or Android smartphone operating systems, and for executing computer readable instructions of applications (apps). Exemplary applications processing units include Nvidia Tegra, Qualcomm Snapdragon, S4, Exynos, and Apple A6. Program memory 720 is a data storage device that stores processor-executable instructions. Programs stored in program memory 720 include operating system 722. Programs stored in program memory 720 further include weather forecast display application 724, which includes instructions which, when executed by applications processor 710, cause applications processor 710 to perform the steps of providing permissions and data to permit and authorize payment card processor systems or other systems to search databases for subscriber travel data, generate itineraries, and provide itineraries to user device 700. The instructions of weather forecast display application 724 further cause applications processor 710 to access itinerary data from other systems, access weather forecast data for locations identified in the itinerary data, correlate itinerary data and weather forecast data, and determine a display of sequenced and correlated locations, dates and weather forecasts, in accordance with the sequenced and correlated dates and locations of the itinerary. In embodiments, the instructions of weather forecast display application 724 may cause applications processor 710 to access correlated itinerary and weather forecast data form other systems, and generate displays of sequenced and correlated locations, dates and weather forecasts.

User device 700 further includes wireless communications components, including wi-fi transceiver 730, which is in bi-directional communication with applications processor 710, and with wi-fi antenna 732. Wi-fi transceiver 730 and wi-fi antenna 732 provide for two-way wireless communication between user device 700 and other devices and networks via wi-fi protocols (e.g., the IEEE 802.11 family of protocols). The wireless communications components of user device 700 further include baseband processor 740, in communication with applications processor 710. Baseband processor 740 is further in communication with transceiver 742 and wireless antenna 744. Baseband processor 740, transceiver 742 and wireless antenna provide wireless communications via cellular protocols, such as GSM, UMTS, LTE Advanced and CDMA, by way of example.

User device 700 further includes display controller 750, in communication with applications processor 710, which provides generation of display data for display on display device 760. Display device 760 may be, by way of example, a touchscreen display. Display 761 includes exemplary correlated date, location and weather forecast data blocks or portions, such as block 762, in accordance with the exemplary itinerary shown in FIG. 5, where today is Aug. 3, 2015. Blocks 762, 764, 766, 768 and 770 have been arranged in chronological order, in accordance with the itinerary. In this embodiment, for day in which the itinerary identifies multiple locations for the subscriber, a separate block is provided for each location for that day. Thus, as the itinerary shown in FIG. 5 identifies three locations for Aug. 4, 2015, the display 761 generated by weather forecast display application 724 includes three blocks for Aug. 4, 2015. In this embodiment, each block is populated with an indication of a day, a location, both from the itinerary data and weather forecast data obtained from a weather forecast source, including a high temperature forecast, and an icon representing a predicted likelihood of precipitation, cloudy skies or clear skies. The location data is shown as a city or city and state, as reflected in the itinerary. In embodiments, the weather forecast data may include additional data, such as low temperature data, percentage likelihood of precipitation, and other data. The likelihood of precipitation may be shown as text data or in other formats. The number and arrangement of blocks 762-770 is merely exemplary, and may vary in embodiments.

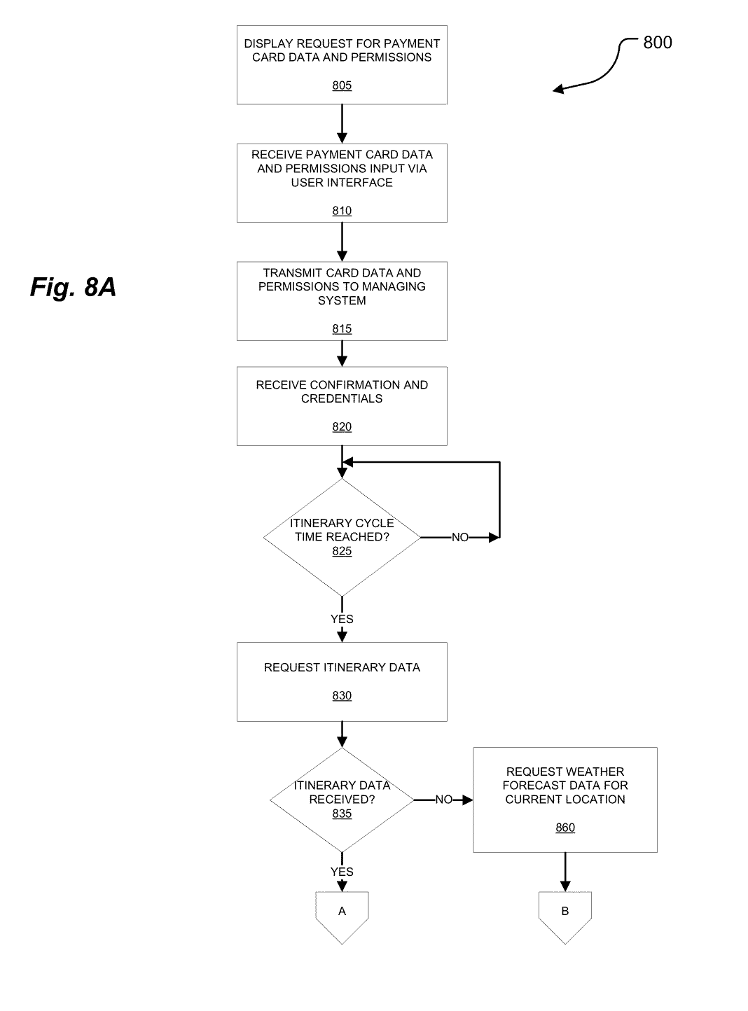

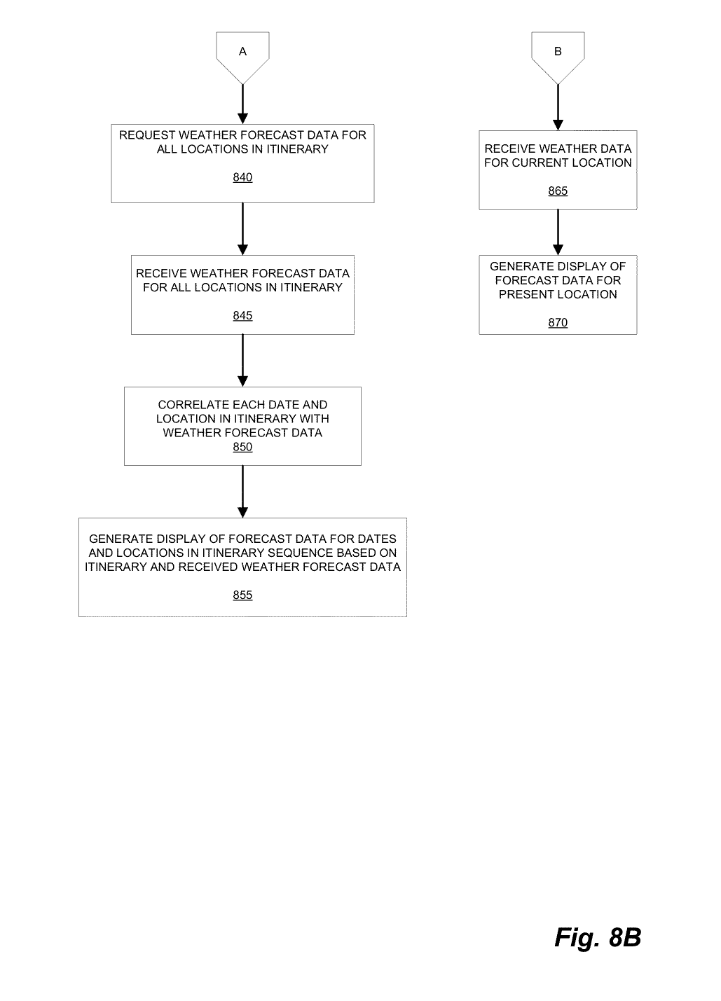

Referring now to FIGS. 8A and 8B, there is shown a process flow diagram of an illustrative process flow that may be implemented by applications processor 710 executing instructions of weather forecast display application 724. An application program may be downloaded to the user device and installed. Upon activation, the application program may cause the device to display 805 on its screen a request for payment card data and permissions for the device and the payment card processor to use the user's identity, payment card data, and other information in connection with searches of travel related data for the purposes of providing customized weather forecast displays. The prompts may display click boxes, virtual buttons and other interface icons, such as on a touchscreen, to permit the user to grant or decline permissions. The prompts may include fields for providing name, payment card numbers, address, frequent flier and other rewards card numbers, and other data that may be useful in associating travel data with a user. The prompts and permissions may be provided in one or more screens displayed in any suitable order. The device then receives 810 via the touchscreen or other user input device, permissions and other data. The permissions, payment card data, user name and other data are then transmitted 815 by the device to a computer system, such as managing computer system 110 of FIG. 1, that performs data processing tasks for managing a system and method according to an embodiment of the invention. The user device then receives 820 from the managing computer system data including a confirmation and credentials, such as a device identification and suitable credentials for secure transmission of data. The applications processor stores the received credentials for use by the weather forecast display application program.

The weather forecast display application program then proceeds to an operating cycle. The weather forecast display application program may have a cycle time for checking for updated itineraries. For example, the weather forecast display application program may check for updated itineraries once every 24 hours, once every 12 hours, once every 6 hours, or on another basis. Responsive to determining that the cycle time has been reached 825, i.e., that at least the cycle time has elapsed subsequent to the most recent time that the managing computer system was checked for itineraries for the subscriber, the process flow proceeds to requesting 830 itinerary data from a source of itinerary data, such as a managing computer system of a card payment processor. The request may be in the form of an xml format message transmitted to the source of itinerary data, and including credentials, device identification, an indication that the message is a request for itinerary data, and a range of dates of interest. The process flow then proceeds to determining whether itinerary data has been received 835 from the source of itinerary data. Responsive to determining that itinerary has been received, such as via responsive xml message, referring now to FIG. 8B, the process flow proceeds to requesting 840 weather forecast data for all locations in the itinerary. The request may include a separate request to a source of weather forecast data, such as to an API interface of a commercial or government weather forecast data source, for each location in the itinerary. The process flow then proceeds to receiving 845 weather forecast data for all locations in the itinerary. It will be appreciated that the process flow may loop through requesting weather forecast data and then receiving weather forecast data for each location in succession, in embodiments. The process flow then proceeds to correlating 850 each date and location in the itinerary with weather forecast data. The correlating may include generating a list of ordered sets of display data. Each set of display data may include date information, location information, and one or more items of weather forecast data. Each set may correspond to one ordered set of date and location information from the itinerary. In embodiments, the process flow may include generating more granular sets of location, date or time information and weather forecast data than provided in the itinerary. For example, the itinerary date data may only indicate date, while the sets of data may include for a single date, forecasts during periods, such as morning, midday, afternoon, evening and night, ranges of hours, or selected times of day. In embodiments, the itinerary data may be more granular, such as indicating time ranges during a date when the user is expected to be in a particular location, in which case the correlation process may generate a set corresponding to each time range provided in the itinerary data. The process flow then proceeds to generation 855 of a display of forecast data for dates and locations in the itinerary sequence, based on the ordered sets of location and date, or time and date, data in the itinerary, and the weather forecast data.

Referring again to FIG. 8A, responsive to determining at step 835 that no itinerary data has been received, the process flow proceeds to requesting 860 weather forecast data for a current location of the user device. The weather data is received 865 from the source of weather forecast data. The process flow then proceeds to generation 870 of weather forecast data for a present location. Thus, if there is no itinerary, the device is configured to display ordered sets of weather forecast data for a series of days or times for a present location. The display may include or exclude, in embodiments, the location.

In embodiments, the user device may be configured to subscribe to a service providing weather alerts for a location for a time period corresponding to the expected duration of the user's presence in a given location. For example, on a cycle, such as a 24 hour or other cycle, the device may, executing instructions of the weather forecast display application, subscribe to a service that provides urgent warnings, such as via e-mail message or text message, in response to actual or anticipated severe weather events in each location in the itinerary for an upcoming period of time, such as one day to four days. The device may unsubscribe for a given location when the location is no longer among the locations in the itinerary for the upcoming period of time.

In embodiments, the user device may be configured to receive an outgoing message from a managing system with itinerary data, or a request to contact the managing system to receive itinerary data, such as in response to a modification of an itinerary or generation of an itinerary between cycle times.

In embodiments, the user device may be configured to permit the user to interact with a display of location and weather forecast data so as to update location data. For example, each location displayed may serve as a button which, when touched by the user, causes a display to be generated listing alternative locations for user selection or prompting the user to input a location such as via a map display or text entry. The user device may receive an updated or corrected location. In response, the user device may request and receive weather forecast data for the updated or corrected location, and update one or more sets of data to include the corrected display and the corresponding weather forecast. The user device may be configured to provide to the managing system the updated location data. In response, the managing system may update the corresponding itinerary. The managing system may employ one or more rules to correct subsequent date and location sets in the itinerary, and store the updated itinerary for access by the user device, or push the updated itinerary to the user device.

Exemplary advantages of the present method and system include providing a display of weather forecast data, for dates and locations in accordance with a travel itinerary of a user, on a user device, without the need for the user to enter itinerary data.

Each or any combination of the modules and components shown in FIGS. 2 and 7 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, each of the steps of the methods described with reference to FIGS. 8A-8B may be performed by an applications processing unit (APU), which may include one or more processors. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

What is claimed is:

1. A computer system for data processing for determining travel itineraries for display of location-specific weather forecast data on user devices, the system comprising:
one or more data storage devices storing data indicative of user identification data and travel data associated with user identification data;
one or more processors;
a memory in communication with the one or more processors and storing program instructions, the one or more processors operative with the program instructions to:
identify travel events associated with a user based on the data indicative of user identification data and travel data;
generate, based on the travel events, the itinerary comprising data indicative of an ordered list of correlated date data and location data; and
provide data from the itinerary to a user device for display of a weather forecast comprising correlated date, location and weather forecast data in accordance with the itinerary data.

2. The system of claim 1, wherein the travel data comprises one or more of non-cash payment data and global distribution services data.

3. The system of claim 1, wherein the one or more processors operative with the program instructions to generate an itinerary comprises: the one or more processors operative to determine a first travel event of the identified travel events.

4. The system of claim 3, wherein the one or more processors operative with the program instructions to generate an itinerary further comprises the one or more processors operative to verify whether the determined first travel event is a valid first travel event based on validation rules.

5. The system of claim 4, wherein the validation rules comprise a rule comparing a distance between a payment card billing address and a departure airport of a first travel event to a threshold.

6. The system of claim 1, wherein the one or more processors operative with the program instructions to generate an itinerary further comprises the one or more processors operative to determine a second travel event of the identified travel events, and set a location associated with both a destination of the first travel event and a departure of the second travel event as an itinerary location for all dates between the first and second travel events.

7. The system of claim 1, wherein the one or more processors operative with the program instructions to generate an itinerary further comprises the one or more processors operative to use interpolation rules to set a location from a date of a first travel event to a date of a second travel event.

8. The system of claim 1, wherein the one or more processors operative with the program instructions to provide data from the itinerary to a user device comprises the one or more processors operative to receive a request for itinerary, and provide in response to the request data from the itinerary.

9. The system of claim 1, wherein the one or more processors operative with the program instructions to provide data from the itinerary to a user device comprises the one or more processors operative to, responsive to generation of an updated itinerary, generate an outgoing message to the user device with the updated itinerary.

10. A computer-implemented method for data processing for determining travel itineraries for display of location-specific weather forecast data on user devices, the method comprising:
storing in one or more data storage devices data indicative of user identification data and travel data associated with user identification data;
identifying by one or more computer processors travel events associated with a user based on the data indicative of user identification data and travel data;
generating, by the one or more computer processors, based on the travel events, the itinerary comprising data indicative of an ordered list of correlated date data and location data; and
providing by the one or more computer processors data from the itinerary to a user device for display of a weather forecast comprising correlated date, location and weather forecast data in accordance with the itinerary data.

11. The method of claim 10, further comprising accessing by the one or more computer processors weather forecast data corresponding to the dates and location data of the itinerary, and providing correlated weather forecast data and itinerary data to the user device.

12. The method of claim 10, wherein the generating the itinerary comprises determining a first travel event of the identified travel events, and validating the first travel event.

13. The method of claim 12, wherein the generating the itinerary further comprises identifying a second travel event, and setting a location from a date of the first travel event to a date of the second travel event.

14. The method of claim 10, wherein the providing the data from the itinerary to a user device comprises receiving a request from the user device and providing the itinerary data in response to the request.

15. A device for generating a display of weather forecast data in accordance with an itinerary generated by a system from travel events, comprising:
one or more processors;
a memory in communication with the one or more processors and storing program instructions, the one or more processors operative with the program instructions to:
request itinerary data via a network from a computer system having itinerary data;
receive itinerary data, comprising an ordered set of correlated dates and locations generated from travel data;
request, for each of the locations in the itinerary data, from a weather forecast server system, weather forecast data;
receive, for each of the locations in the itinerary data, weather forecast data;
correlate each date and location in the itinerary data with received weather forecast data, including generating a list of ordered sets of display data; and
generate a display of forecast data for dates and locations in the itinerary.

16. The device of claim 15, wherein the one or more processors comprises an applications processing unit, and one or more of the requesting and receiving itinerary data comprises using a baseband processor and a transceiver.

17. The device of claim 15, wherein the one or more processors are further operative with the program instructions to subscribe to a service that provides warnings in response to severe weather events in each of the locations in the itinerary data.

18. The device of claim 15, wherein the one or more processors are further operative with the program instructions to, for each location in the generated display, responsive to user input, receive an updated location.

19. The device of claim 18, wherein the one or more processors are further operative with the program instructions to request and receive weather forecast data for the updated location.

20. The device of claim 19, wherein the one or more processors are further operative with the program instructions to generate in the display a date indication, a location indication, and a weather forecast indication in a plurality of ordered blocks.
